(19) United States
(12) Patent Application Publication
(10) Pub. No.: US 2009/0136803 A1
(43) Pub. Date: May 28, 2009

(54) FUEL CELL SYSTEM

(75) Inventor: Jun Yamamoto, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/066,702

(22) PCT Filed: May 18, 2007
(86) PCT No.: PCT/JP2007/060739

§ 371 Date: Mar. 13, 2008

(30) Foreign Application Priority Data
May 26, 2006 (JP) 2006-146205

(51) Int. Cl. H01M 8/04; H01M 8/00

(52) U.S. Cl. 429/22; 429/12

(57) ABSTRACT

A fuel cell system capable of controlling a fuel cell at a time of starting and at a time of stopping with a simple structure and capable of controlling the influence of the outside air temperature of the use environment. The fuel cell system includes a fuel cell including a power generating portion including a fuel electrode and an oxidizer electrode, for performing power generation based on a fuel supplied from a fuel tank; and a switch provided between the fuel electrode and the oxidizer electrode so as to connect and disconnect a resistor between and with the fuel electrode and the oxidizer electrode. The switching of the connection and disconnection of the resistor by the switch is performed based on at least one temperature difference between two of the power generating portion of the fuel cell, the fuel tank, and outside air.

### TECHNICAL FIELD

The present invention relates to a fuel cell system, and specifically to a fuel cell system for controlling a fuel cell at the time of starting and at the time of stopping based on temperatures at the respective times.

### BACKGROUND ART

In recent years, mobile electronic devices, such as cellular phones, personal data assistants (PDAs), notebook type personal computers, digital cameras, and digital video cameras, have become multifunctional. The amount of information processed by these devices is increasing, resulting in a continuing increase in power consumption.

For this reason, it is strongly desired to provide a higher energy density power source, which is to be mounted to those devices.

A fuel cell is a device in which a fuel, such as hydrogen, and an oxidizer, such as oxygen, are chemically reacted with each other to generate chemical energy, which is directly converted into electrical energy.

The fuel cell described above has a higher energy density in the fuel so that energy capacities per volume and per weight can be increased compared with the conventional batteries. In addition, if such a structure is employed that oxygen is taken in from outside air, it is not necessary to provide an oxidizer material, and the energy capacities per volume and per weight can be further enhanced.

Among the fuel cells, a polymer electrolyte fuel cell (PEFC) has a full solid structure using as an electrolyte a polymer film, so that the fuel cell has characteristics such as ease of handling, a simple structure, operability at low temperature, and a short period of time for the start of the fuel cell. From the characteristics described above, it can be said that the fuel cell is suitable as a power source to be mounted to the mobile electronic devices.

The polymer electrolyte fuel cell basically includes a polymer electrolyte membrane having proton conductivity and a pair of electrodes provided on both surfaces of the polymer electrolyte membrane.

Each electrode includes a catalyst layer made of platinum or a platinum group metal and a gas diffusion electrode formed outside of the catalyst layer for supplying a gas and collecting current.

An assembly obtained by integrating the electrodes and the polymer electrolyte membrane into one is referred to as a membrane electrode assembly (MEA) in which a fuel is supplied to one of the electrodes and an oxidizer is supplied to another electrode to conduct power generation.

A theoretical voltage of a membrane electrode assembly is about 1.23 V, and under normal operation conditions, the membrane electrode assembly is driven at about 0.7 V in many cases. Accordingly, in a case where a higher voltage is required, a plurality of cell units are stacked and arranged electrically in series to be used.

This type of stacked structure is called a fuel cell stack. In the stack, normally, an oxidizer flow path and a fuel flow path are isolated by a member called a separator.

Various types of fuels may be used in the fuel cell. Examples of methods of supplying the fuel include a method of directly supplying a liquid fuel, such as methanol; a method of supplying hydrogen; and a method of modifying the liquid fuel to generate hydrogen and supplying the hydrogen to the fuel electrode.

Of those, the hydrogen supply system is preferable for use in mobile electronic devices due to the advantages of high output and small size.

To operate the fuel cell system, there has been proposed a method of controlling the operation of the fuel cell at the time of starting and at the time of stopping by using a resistor connected between the fuel electrode and the oxidizer electrode of the fuel cell.

At the time of starting the fuel cell, it is necessary to humidify a polymer electrolyte membrane as soon as possible to obtain stable electric characteristics.

For the polymer electrolyte membrane to be used, it is required to have characteristics, such as proton conductivity, gas barrier property, electronic insulating property, chemical and electrical stability, heat resistance, and high mechanical strength.

To provide these characteristics, perfluorosulfonic acid-based ion-exchange resins are particularly preferable and are used widely.

In the polymer electrolyte membranes formed of perfluorosulfonic acid-based ion-exchange resins, accompanying water is necessary for the proton conductivity. Therefore, in a case where water content in the polymer electrolyte membrane is low, proton conductivity is low, whereas, the proton conductivity is high in the case where the water content is high.

The proton conductivity of the polymer electrolyte membrane considerably influences the internal resistance of the fuel cell, thereby greatly affecting power generation characteristics. For that reason, it is important to devise a method of quickly switching to a damped state, which is a state of an increased water content, at the time of starting the fuel cell in the case of the polymer electrolyte membrane generally having a low water content.

In the polymer electrolyte fuel cell, the proton generated at the fuel electrode moves in the polymer electrolyte membrane toward the oxidizer electrode, and a water production reaction takes place at the oxidizer electrode. The water produced at the oxidizer electrode moves from the oxidizer electrode toward the fuel electrode by dispersion caused by the concentration gradient in the polymer electrolyte membrane, whereby the total water content of the polymer electrolyte membrane increases. In order to increase the total water content of the polymer electrolyte membrane within a short period of time, it is preferable that the polymer electrolyte membrane be thin to the extent that the polymer electrolyte membrane may achieve functions, such as preventing cross leaking of the fuel and the oxidizer and securing an electrical insulating property between both electrodes.

At the time of starting the fuel cell, in order to rapidly humidify the polymer electrolyte membrane with water produced by the power generation reaction and increase the proton conductivity of the polymer electrolyte membrane to a steady state, it takes time and further a sufficient activation cannot be obtained in a case where the current density is low. Accordingly, it is necessary to supply current into a fuel cell unit with a current density as large as possible. However, if the supply of current is conducted with an excessive current density when the water content of the polymer electrolyte membrane is low and the internal resistance thereof is high, the supply of the protons becomes insufficient and a polarity inversion occurs, which may damage the fuel cell unit.

Therefore, at the time of starting the fuel cell, the resistor is connected between the fuel electrode and the oxidizer electrode of the fuel cell before the supply of electricity to the electronic device is performed.

The connection of the resistor between both electrodes causes a short circuit current generated by the power generation to flow, and then the water produced at the oxidizer electrode increases the water content of the polymer electrolyte membrane, thereby resulting in stabilizing the electric characteristics of the fuel cell.

The connection of the resistor to the fuel cell unit alone does not cause the flow of the excessive current, and a maximum current is caused to flow as the short circuit current in accordance with an activation state of the fuel cell. As a result, it is possible to obtain the stable electric characteristics of the fuel cell without causing a problem of the polarity inversion and within a short period of time. The stable electric power supply becomes enabled by switching off the short circuit current and by starting the electric power supply to the electronic device upon reception of a judgment that the electric characteristics of the fuel cell are sufficiently activated.

At the time of stopping the fuel cell, it is necessary to consume residual fuel to prevent the degradation of the fuel cell.

In the polymer electrolyte fuel cell, if the gases at the fuel electrode and the oxidizer electrode are left in a residual state while the operation of the fuel cell is stopped (circuit connecting an output terminal of the fuel cell and a load is in an open state), catalytic combustion is caused.

In other words, if the gases are left in the residual state, cross leaking occurs. This is a phenomenon in which a gas on the side of one electrode gradually passes through the electrolyte membrane to reach the other electrode. If the cross leaking occurs, the fuel and the oxidizer directly react with each other on the catalyst, thereby causing catalytic combustion. The catalytic combustion generates a large amount of thermal energy to degrade the materials constituting the fuel cell.

Also, the residue of the gases causes a difference in potential between the fuel electrode and the oxidizer electrode. It is known that if the state is left as it is, the degradation of the constituting materials is promoted depending on the level of the potential difference.

To prevent the degradation described above, at the time of stopping the fuel cell, the connection of the resistor is established between the fuel electrode and the oxidizer electrode of the fuel cell to enable prompt consumption and removal of the residual fuel.

In a small-size fuel cell system directed to mobile electronic devices, it is necessary to provide a single mechanism capable of controlling the fuel cell at the time of starting and at the time of stopping in order to avoid an enlargement of the system as well. Further, it is more preferable to conduct the control described above by using a passive mechanism in order to reduce the number of additional devices, such as a control circuit.

It has been proposed to control the fuel cell at the time of starting and at the time of stopping on the basis of an absolute temperature.

Japanese Patent Application Laid-open No. 2005-327587 proposes a fuel cell employing a structure in which a member exhibiting conductivity at room temperature and exhibits non-conductivity at a predetermined temperature higher than room temperature is connected between the fuel electrode and the oxidizer electrode of the fuel cell.

As the member to be connected between the fuel electrode and the oxidizer electrode of the fuel cell, a PTC member (temperature variable resistor, such as a PTC thermistor) containing barium titanate or the like as a component, is used.

Japanese Patent Application Laid-open No. 2005-166547 proposes a starting device for a fuel cell system, in which a load circuit including a temperature switch, such as a bimetal, is connected between the fuel electrode and the oxidizer electrode of the fuel cell, and the switch is controlled into a closed state at room temperature and controlled into an open state at a predetermined temperature higher than room temperature.

In the related arts described in the Japanese Patent Application Laid-open No. 2005-327587 and Japanese Patent Application Laid-open No. 2005-166547, the controls of the fuel cell at the time of starting and at the time of stopping are conducted as described below.

At the time of starting, the fuel cell starts the power generation in the case where the resistor is connected between the fuel electrode and the oxidizer electrode, the fuel cell reaches a predetermined temperature or more due to the heat generated by the power generation, and the resistor is disconnected. At the predetermined temperature or more, the disconnection state of the resistor is maintained.

Further, at the time of stopping the fuel cell, when the temperature of the fuel cell reaches the predetermined temperature or lower, the connection of the resistor is established between the fuel electrode and the oxidizer electrode. The temperature to be measured in this case is not relative, but is an absolute temperature of the fuel cell.

In the related arts disclosed in the above-mentioned Japanese Patent Application Laid-open No. 2005-327587 and Japanese Patent Application Laid-open No. 2005-166547, the fuel cell at the time of starting and at the time of stopping is controlled based on the absolute temperature as described above. Accordingly, there still remains a problem in that the controls of the fuel cell are influenced by the outside air temperature in which the fuel cell is used.

When the fuel cell is mounted onto mobile electronic devices, the fuel cell is used either on the outside or the inside of the device through all seasons. Therefore, it is necessary for the fuel cell to take into account the temperature difference between the summer season and the winter season. However, the predetermined temperature used for the control of the fuel cell must be set to a temperature higher than that of the summer season.

Accordingly, there arises a large difference in time and fuel consumption until the temperature of the fuel cell reaches the predetermined temperature depending on an ambient temperature.

If the predetermined temperature for the control is set to 60° C. with respect to the start of the fuel cell at the ambient temperature that it at a freezing point or lower, it may not be possible to raise the temperature of the fuel cell to the predetermined temperature in the case where the fuel cell is designed for the purpose of low output.

Also, even if the fuel cell is designed for the purpose of high output and has a large heating power, a considerable amount of time and fuel are spent until the temperature of the fuel cell reaches the predetermined temperature. Such time and fuel consumption, which are spent for stabilizing the electric characteristics of the fuel cell by humidifying the polymer electrolyte, are thought to be excessive and wasteful.

### DISCLOSURE OF THE INVENTION

To solve the above-mentioned problems, the present invention is directed to a fuel cell system capable of controlling an influence of an outside air temperature in a use environment and capable of performing such control with a simple structure.

To solve the above-mentioned problems, the present invention provides a fuel cell system constructed as described below.

A fuel cell system according to the present invention includes a fuel cell including a power generating portion for performing power generation based on a fuel supplied from a fuel tank, the power generating portion including a fuel electrode and an oxidizer electrode; and a switch provided between the fuel electrode and the oxidizer electrode so as to connect and disconnect a resistor between and with the fuel electrode and the oxidizer electrode. The switching of the resistor between a connected and a disconnected state is performed based on at least one temperature difference between two of the power generating portion of the fuel cell, the fuel tank, and outside air.

According to the present invention, when controlling the fuel cell at a time of starting and at a time of stopping the fuel cell, the fuel cell system is capable of controlling an influence of an outside air temperature in a use environment. In addition, the controls described above may be made with a simple structure.

Further features of the present invention will become apparent from the following description of exemplary embodiments with reference to the attached drawings.

### BRIEF DESCRIPTION OF THE DRAWINGS

FIG. 1 is a schematic diagram illustrating a structure of a fuel cell system according to a first embodiment of the present invention.

FIG. 2 is a schematic diagram illustrating a structural example of connecting a resistor to a fuel cell stack according to the first embodiment of the present invention.

FIG. 3 is a schematic diagram illustrating another structural example of connecting resistors to the fuel cell units according to the first embodiment of the present invention.

FIG. 4 are graphs each illustrating a temperature of a power generating portion of the fuel cell and a temperature of a fuel tank at a time of starting the fuel cell system, and a change with the elapse of time in a temperature difference between both temperatures, for illustrating the first embodiment of the present invention.

FIG. 5 are graphs each illustrating the temperature of the power generating portion of the fuel cell and the temperature of the fuel tank at a time of stopping the fuel cell system, and a change with the elapse of time in a temperature difference between both temperatures, for illustrating the first embodiment of the present invention.

FIG. 6 is a schematic diagram illustrating a structure of a fuel cell system according to a second embodiment of the present invention.

FIG. 7 is a schematic diagram illustrating a structural example of a fuel cell system according to a third embodiment of the present invention.

FIG. 8 is a schematic diagram illustrating another structural example of a fuel cell system according to the third embodiment of the present invention.

### BEST MODE FOR CARRYING OUT THE INVENTION

Now, a description will be made of an embodiment mode of the present invention. In a fuel cell system according to the embodiments of the present invention, a resistor is connected between a fuel electrode and an oxidizer electrode of a fuel cell, or a control for disconnecting the connection the resistor is conducted by an electromotive force of a thermoelectric transducer. Therefore, the control of the fuel cell is not based on an absolute temperature, but is based on a temperature difference, whereby the influence of an outside air temperature in a use environment is prevented. As a result, constant control of the fuel cell can be performed irrespective of the outside air temperature. Consequently, the fuel cell system of the present invention is very useful for the fuel cell used either indoors or outside and through all the seasons.

In addition, in accordance with the present invention, there may be employed a method of using two temperature sensors for sensing a temperature difference and measuring the respective temperatures to calculate a difference therebetween. However, the number of the sensors may be reduced to one by utilizing the electromotive force of the thermoelectric transducer, which is more preferable.

Further, a thermal energy variation associated with the operation of the fuel cell system may be positively utilized in the thermoelectric transducer, whereby the efficiency of energy use can be enhanced.

Also, in a case where the operation of a switch for establishing a connection of a resistor between the fuel electrode and the oxidizer electrode of the fuel cell is performed using the electromotive force of the thermoelectric transducer, this operation is free from an electric power consumption from an external electric power source.

Now, descriptions will be made of the embodiments of the present invention.

### First Embodiment

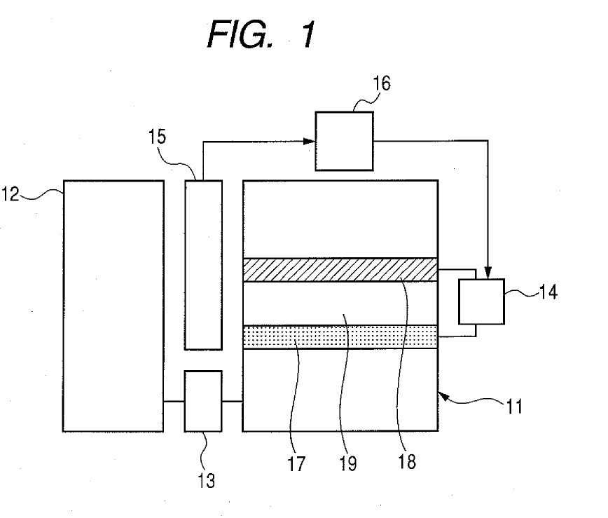

In a first embodiment of the present invention, a description will be made of a fuel cell system to which the present invention is applied. FIG. 1 is a schematic diagram illustrating a structure of a fuel cell system according to the first embodiment of the present invention. In FIG. 1, the fuel cell system includes a fuel cell 11, a fuel tank 12, a fuel supply controller 13, a switch 14, a thermoelectric transducer 15, a control unit 16, a fuel electrode 17, an oxidizer electrode 18, and a solid polymer electrolyte membrane 19.

The fuel cell system according to the present invention includes the fuel cell 11 including a power generating portion including the fuel electrode 17 and the oxidizer electrode 18; a fuel tank 12 for supplying fuel to the fuel cell 11; and a switch 14 for establishing a connection of a resistor between the fuel electrode 17 and the oxidizer electrode 18 of the fuel cell 11.

In this embodiment, the connection and disconnection of the resistor performed by the switch 14 is performed based on an electromotive force of the thermoelectric transducer 15, which converts a temperature difference between two of a temperature of the power generating portion of the fuel cell 11, a temperature of a fuel tank 12, and an outside air temperature into electric power.

For the fuel cell 11 of this embodiment, any fuel, such as pure hydrogen and methanol, may be used, as well as any system for supplying the fuel.

The power generating portion of the fuel cell 11 includes a polymer electrolyte membrane 19 having proton conductivity and two electrodes including the fuel electrode 17 and the oxidizer electrode 18, which are provided on both sides of the polymer electrolyte membrane 19 and are formed of a catalyst layer and a gas diffusion layer.

Hydrogen fuel is supplied to the fuel electrode 17 from the fuel tank 12, whereas oxygen is supplied to the oxidizer electrode 18 through natural diffusion.

As a material of the polymer electrolyte membrane 19, any material may be used, but perfluorosulfonic acid-based proton-exchange resin membrane 19 is preferable.

The polymer electrolyte membrane 19 needs to be quickly and entirely humidified by inverted diffusion of water produced at the oxidizer electrode 18. Therefore, it is desirable for the polymer electrolyte membrane 19 to be as thin as possible. However, from the viewpoints of mechanical strength, gas barrier property, etc. of the membrane, the thickness of about 50 μm may be preferable.

A membrane electrode assembly for a polymer electrolyte fuel cell is fabricated as follows.

First, catalyst particles, such as platinum black, catalyst carrying particles, such as platinum-carrying carbon, a polymer electrolyte solution, and an organic solvent, such as isopropyl alcohol, are mixed together to produce a catalyst ink.

Then, the catalyst ink is applied to and form a film on a polymer film, such as polytetrafluoroethylene (PTFE) and a carbon electrode substrate of an electroconductive porous body by a spray coating method, a screen printing method, or a doctor blade method, to thereby form a catalyst layer.

Next, the thus obtained catalyst layer is contact-bonded on both sides of the polymer electrolyte membrane by a thermal transfer or the like such that the catalyst carrying side faces inside, whereby the membrane electrode assembly for the polymer electrolyte fuel cell can be obtained. The fuel tank 12 may be of any type as long as it is capable of supplying the hydrogen fuel to the fuel cell 11. The fuel includes pure hydrogen, hydrogen stored in a hydrogen storage material, and liquid fuels, such as methanol and ethanol.

Further, there may be employed a system for supplying a liquid fuel to the fuel cell or a system for using a modifier and supplying a modified hydrogen to the fuel cell.

In this embodiment, it is preferable to employ a structure in which the temperature difference occurs at the time of operation of the fuel cell system. Accordingly, it is preferable to charge the fuel tank 12 with high pressure hydrogen or hydrogen stored by a hydrogen storage alloy.

In this case, the release of hydrogen from the fuel tank 12 involves absorption of heat, so that the fuel tank 12 is cooled at the time of operation of the fuel cell system.

In addition, if the hydrogen storage alloy is used, the hydrogen may be stored at a lower pressure with high efficiency, which is more preferable.

To prevent the hydrogen fuel supplied from the fuel tank 12 from leaking from a fuel flow path and a fuel electrode chamber to the outside of the fuel cell system, the connecting portions between respective parts are subjected to a sealing process to maintain a closed state.

The fuel supply controller 13 can perform the supply of the fuel from the fuel tank 12 to the fuel cell 11 at the time of operation of the fuel cell system, whereas the supply of the fuel is interrupted by receiving a stop signal sent from the electronic device or the like at the time of stopping.

There is provided an electromagnet valve as a unit for controlling the supply of fuel by receiving such an electrical signal.

Further, the fuel cell in accordance with the present invention may have a structure in which the fuel tank 12 and the fuel cell 11 are connected through a connector, and a coupling of a connection port is opened when the connector is connected therebetween, whereas, the coupling is closed when the connector is detached. The present invention may also employ a method of interrupting the supply of the fuel by detaching the fuel tank 12 at the time of stop.

The switch 14 includes a mechanism for connecting a resistor between the fuel electrode 17 and the oxidizer electrode 18 of the fuel cell 11, and the operation of connecting the resistor therebetween is performed by an electromotive force of the thermoelectric transducer 15.

The connection of the resistor is performed such that the switch circuit including the resistor is maintained in a connection state between the both electrodes, and an open/close control of the switch is performed.

Further, the open/close control is performed by a control unit 16.

The resistor may be arbitrarily selected depending on its design. However, taking into consideration a prompt operation at the time of starting or at the time of stopping, it is preferable to use a low resistance material having a low resistivity, such as metals.

Further, the fuel cell 11 of this embodiment may be a fuel cell stack having a plurality of fuel cell units stacked therein.

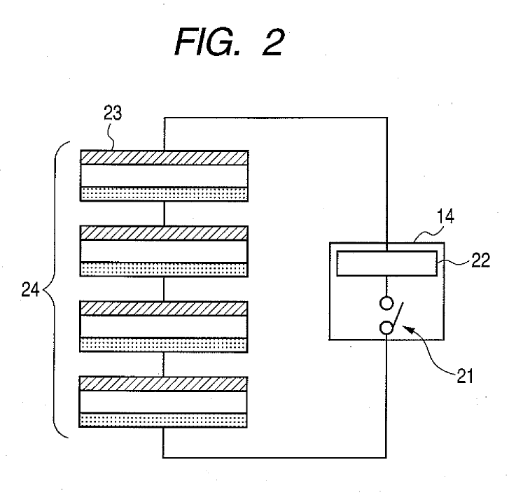

At that time, as shown in FIG. 2, a resistor 22 is provided to a fuel cell stack 24 having a plurality of stacked fuel cell units 23, and connection and disconnection can be freely performed by a switch 21.

As shown in FIG. 2, the resistor 22 is connected between output terminals of the fuel cell stack 24. However, there occurs a fluctuation of electric voltage distribution among the fuel cell units 23 and there is a risk of causing polarity inversion of a part of the fuel cell units 23.

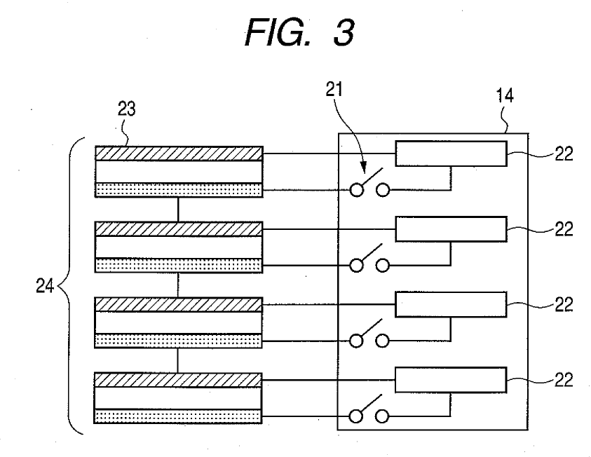

Therefore, as a method for connecting the resistor 22 in the case described above, it is preferable that the resistor 22 be connected to an individual fuel cell unit 23 as shown in FIG. 3.

The thermoelectric transducer 15 is arranged so as to obtain the electromotive force based on any one temperature difference between two of (i) the power generating portion of the fuel cell 11, (ii) the fuel tank 12 and (iii) outside air, namely, the temperature difference between (i) and (ii), the temperature difference between (ii) and (iii), and the temperature difference (i) and (iii). However, the thermoelectric transducer 15 is preferably provided between the power generating portion of the fuel cell and fuel tank.

This is because the power generating portion of the fuel cell becomes a high temperature source due to heat associated with a power generation reaction, and further, the fuel tank becomes a low temperature source due to heat absorption associated with the hydrogen release, thereby providing the largest temperature difference within the fuel cell system. For example, in the case of the normal polymer electrolyte fuel cell, the temperature of the power generating portion under normal operation is about 80° C., whereas, the temperature of the hydrogen storage alloy is the freezing point or less depending on the kinds of alloy and a selection of dissociation pressure of the hydrogen gas. In the actual fuel cell system, from the viewpoints of prevention of degradation of the fuel cell system, acceleration of the release of hydrogen, and prevention of dew formation, the flow of heat is generated between the power generating portion and the fuel tank, so that the excessively large temperature difference does not appear. However, the temperature difference of about 30° C. may be sufficiently secured between the power generating portion and the fuel tank.

The temperature of the power generating portion of the fuel cell may rise to the highest temperature in a catalyst layer of an oxidizer electrode of the fuel cell unit. This is because when a proton is oxidized in the catalyst layer of the oxidizer electrode, the residual energy, which is not extracted as an electrical energy, becomes heat. Accordingly, it is most efficient to measure the temperature of the power generating portion at a closed portion of the oxidizer electrode. However, in a case where it is difficult to incorporate a sensor into the closed portion of the oxidizer electrode because of a structural problem, the temperature of another portion, for example, the temperature of the separator inserted between the fuel cell units, may be determined, or the measurement may be made on a surface of a wall of an outer cell structure of the fuel cell by designing in consideration of heat transfer. In the case of employing a structure in which an oxidizer gas, such as oxygen gas or air, is caused to flow to the oxidizer electrode, the temperature of an outlet of the gas flow may be measured to determine the temperature of the power generating portion.

The temperature of the fuel tank becomes the lowest inside the tank. However, it is a normal case to measure the temperature of a wall surface of an outer cell structure of the tank.

An outside air temperature is preferably measured at a portion as far away as possible from the power generating portion of the fuel cell or the fuel tank where heat generation or heat absorption occurs. However, when a heat insulated structure is employed at those portions, it is possible to sufficiently measure the outside air temperature even if the distance therebetween is small. When the air intake structure is adopted, it is preferable to measure the outside temperature at the close portion of the air intake portion.

The electromotive force generated at this time is expressed by α×ΔT, where a temperature difference between the power generating portion of the fuel cell as the high temperature source and the fuel tank as the low temperature source is represented by ΔT, and Seebeck coefficient of the thermoelectric transducer is represented by α.

The thermoelectric transducer preferably has a structure in which a p-type semiconductor and an n-type are connected alternately to obtain a higher voltage. As is conventionally well known, (Bi, Sb)₂Te₃ or the like can be used for the p-type semiconductor, and Bi₂(Te, Se)₃ or the like can be used for the n-type semiconductor as the materials thereof. Also, p-n conjunction type oxide materials or organic materials may be used therefor. In a case where those thermoelectromotive force devices are used, and when a temperature difference is, for example, 30° C., 7 mW/cm² of the thermoelectromotive force can be obtained.

Further, the electromotive force generated by the thermoelectric transducer may be used for charging a capacitor, a secondary battery or the like, or may be used as a driving electric force for auxiliary devices. The usage of the electric force leads to positive utilization of the thermal energy fluctuation associated with the operation of the fuel cell system, which contributes to increase the energy use efficiency.

The control unit 16 detects the electromotive force of the thermoelectric transducer 15. When the electromotive force is smaller than a predetermined value, the control unit 16 performs a control such that the switch 14 is switched to a connection state, whereas, when the electromotive force is a predetermined value or more, the switch 14 is switched to a disconnection state.

The control method thereof is, for example, as described above, such that the switch circuit including a resistor is maintained at a connection state between both electrodes, and an opening/closing of the switch is controlled.

The predetermined value may be arbitrarily selected based on changes in the temperature difference and electromotive force associated therewith from the start to the stable operation of the fuel cell system. Without influencing the changes by the outside air temperature, the predetermined value may be so as to reach the stable operation.

Now, operations of the fuel cell system at the time of starting and at the time of stopping will be described.

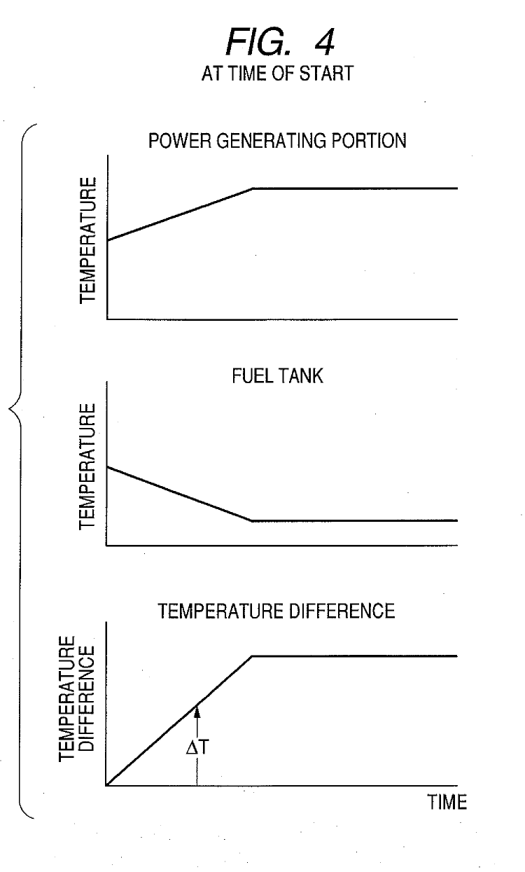

FIG. 4 illustrates a temperature of the power generating portion of the fuel cell 11 and a temperature of the fuel tank 12 at the time of starting the fuel cell system and a change with the elapse of time in the temperature difference between both the temperatures.

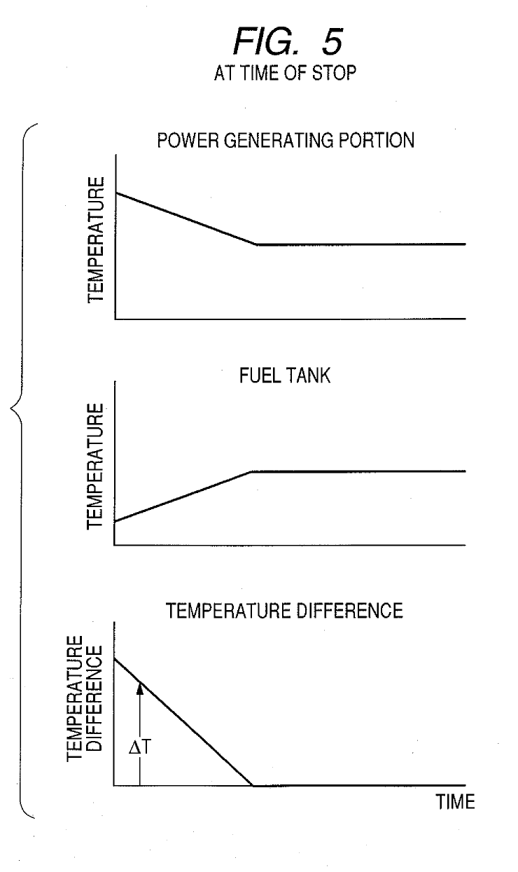

Further, FIG. 5 illustrates the temperature of the power generating portion of the fuel cell 11 and the temperature of the fuel tank 12 at a time of stopping the fuel cell system and a change with the elapse of time in the temperature difference between both temperatures.

At the time of starting the fuel cell system, the fuel cell 11 and the fuel tank 12 each have a temperature close to an outside air temperature. Therefore, the temperature difference between the fuel cell 11 and the fuel tank 12 is small, so that the resistor 22 is maintained in a connection state by the switch 14, in advance, between the fuel electrode 17 of the fuel cell and the oxidizer electrode 18.

In reply to a start signal, the fuel supply controller 13 allows the fuel of the fuel tank 12 to be supplied to the fuel cell 11, the fuel cell 11 starts to activate for humidifying the polymer electrolyte membrane 19 by self-power-generation due to the connection of the resistor 22.

At this time, the fuel cell 11 emits thermal energy in addition to electric energy, resulting in an increase in the power generating portion temperature.

In contrast, the fuel tank 12 is cooled more due to the temperature absorption in accordance with the supply of hydrogen to the fuel cell 11.

For this reason, the temperature difference AT between the fuel cell 11 and the fuel tank 12 gradually becomes large at the time of starting.

The thermoelectric transducer 15 is provided between the fuel cell 11 and the fuel tank 12, so that the electromotive force of the thermoelectric transducer becomes larger in accordance with the change of the temperature difference between the fuel cell 11 and the fuel tank 12 at the time of starting.

The control unit 16 detects the electromotive force of the thermoelectric transducer 15, and when the electromotive force is a predetermined value or higher, the control unit 16 performs a control to disconnect the connection of the resistor 22.

By the disconnection of the connection of the resistor 22, the supply of the output to the mounted electronic device is started and the power generation state becomes stable. As a result, the temperature of the power generating portion and the temperature of the fuel tank 12 fall within a constant temperature range.

For this reason, the temperature difference AT is always maintained in a certain range or more. Accordingly, at the time of the operation, a load connection portion is maintained in a state of disconnecting the connection of the resistor 22.

However, when the fuel cell system receives a power generation stop order at the time of the stopping the operation of the fuel cell system, the supply of the output to the mounted electronic device is stopped, and the fuel supply controller 13 interrupts the flow path between the fuel cell 11 and the fuel tank 12 to stop the supply of the fuel.

Although the temperature of the fuel cell 11 was raised at the time of operation of the fuel cell system, the temperature of the fuel cell gradually falls due to the stop of the operation thereof and approaches the outside air temperature. However, although the temperature of the fuel tank 12 decreased at the time of operation of the fuel cell system, the temperature of the fuel tank gradually rises due to the stop of the release of the hydrogen and approaches the outside air temperature.

Because of this, the temperature difference AT between the fuel cell 11 and the fuel tank 12 gradually becomes small at the time of stopping.

The electromotive force of the thermoelectric transducer becomes smaller in accordance with the change of the temperature difference between the fuel cell 11 and the fuel tank 12.

The control unit 16 detects the electromotive force of the thermoelectric transducer 15, and when the electromotive force is smaller than a predetermined value, the control unit 16 performs a control of connecting the resistor of the load connection portion. Thus, the residual fuel is consumed.

Further, after the stop of the fuel cell system, the electromotive force of the thermoelectric transducer 15 is hardly generated, and the connection state of the resistor 22 is maintained until the next start.

Thus, the fuel cell system can quickly stabilize the electric characteristics of the fuel cell at the time of starting and can consume the residual fuel at the time of stopping to thereby prevent the degradation of the fuel cell.

In addition, the controls of the fuel cell system at the time of starting and at the time of stopping are performed by the same mechanism, leading to simplification of the fuel cell system.

Further, the connection and disconnection of the connection of the resistor is performed by detecting the temperature difference using the thermoelectric transducer and not by using the absolute temperature. As a result, it is possible to keep the influence of the outside air temperature in a use environment at a minimum, and it is also possible to perform a constant control of the fuel cell system irrespective of the outside air temperature. Further, conventionally, at least two temperature sensors are used for detecting the temperature difference to calculate the difference. However, the electromotive force of the thermoelectric transducer is used for the detection of the temperature difference, whereby the number of the sensors can be reduced to one.

Further, a thermal energy variation associated with the operation of the fuel cell system can be positively used in the thermoelectric transducer, thereby enhancing energy utilization efficiency.

### Second Embodiment

In a second embodiment of the present invention, a description will be made of another mode of a fuel cell system, which is different from the first embodiment.

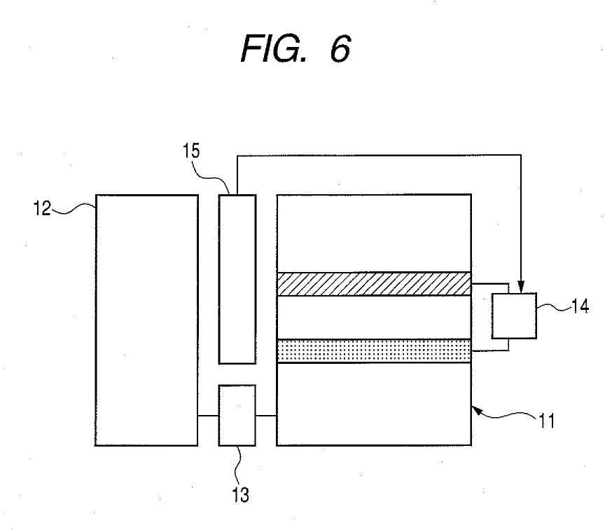

FIG. 6 illustrates a schematic structure of a fuel cell system according to this embodiment.

In the first embodiment of the present invention, the control unit 16 performs the control of the load connection portion based on the electromotive force of the thermoelectric transducer 15. For this reason, in the first embodiment of the present invention, there is required a control unit 16 for detecting the electromotive force and for the operation of the load connection portion. In addition, there is required a supply of an electric power from the outer electric power source other than the fuel cell 11, which is a target to be controlled.

Therefore, this embodiment employs a structure in which a switch is operated by using an electromotive force of thermoelectric transducer 15.

The switch is provided such that a switch circuit including a resistor is maintained in a connection state between the fuel electrode and the oxidizer electrode of the fuel cell.

Then, the switch is configured so as to be controlled into a closed state to establish a connection of the resistor in a case where an electromotive force supplied from the thermoelectric transducer 15 is smaller than a predetermined value and to be controlled into an open state to disconnect the connection of the resistor in a case where the electromotive force is the predetermined value or more.

Examples of switches that perform open/close controls of the switch based on presence or absence of the supply of an electric power include an electromagnetic switch and a semiconductor switch.

In a case where a fuel cell includes a fuel cell stack 24 including a plurality of stacked fuel cell units 23, when the resistor is connected to output terminals of the fuel cell stack 24, there occurs a fluctuation of the electric voltage distribution among the fuel cell units, and there is a risk of causing polarity inversion of a part of the fuel cell units.

Therefore, as a connection method for the resistor as shown in FIG. 3, it is preferable that the resistor be connected to an individual fuel cell unit.

The switch 14 is controlled in its operation based on the changes of the electromotive force of the thermoelectric transducer 15 associated with the start and stop of the fuel cell system.

Thus, the connection and disconnection of the resistor 22 to both electrodes, which are necessary operations at the time of starting and at the time of stopping, can be performed without receiving the supply of an electric power from the external power source, whereby passive control of the fuel cell system can be performed.

### Third Embodiment

In a third embodiment of the present invention, a description will be made of another mode of a fuel cell system, which is different from the above-mentioned embodiments.

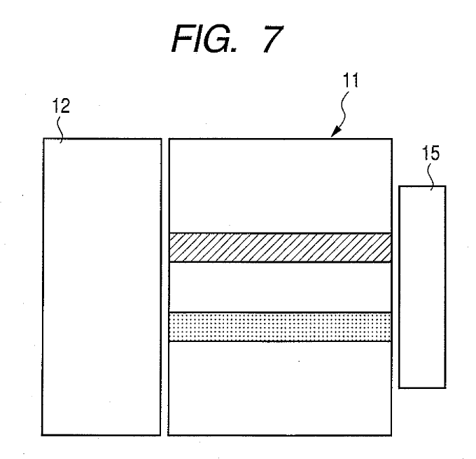

FIG. 7 illustrates a schematic diagram illustrating a structural example of a fuel cell system according to this embodiment.

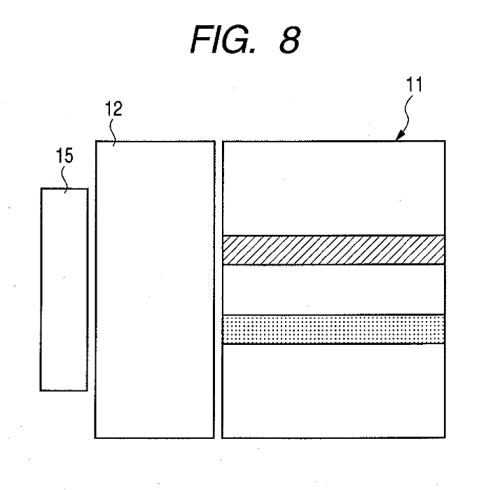

FIG. 8 is a schematic diagram illustrating another structural example of a fuel cell system according to this embodiment.

In the first and second embodiments, it employs a structure in which the thermoelectric transducer is provided between the power generating portion of the fuel cell and the fuel tank.

Taking this structure, the power generating portion of the fuel cell becomes a high temperature source due to heat associated with the operation of the fuel cell, and further, the fuel tank becomes a low temperature source due to heat absorption associated with the hydrogen emission, whereby the largest temperature difference can be obtained within the fuel cell system.

However, a temperature difference between a temperature of the power generating portion at the time of operation of the fuel cell system (high temperature source) and an outside air temperature (low temperature source) and a temperature difference between a temperature of the fuel tank 12 (low temperature source) and an outside air temperature (high temperature source) may be used as a matter of course.

In this case, it is preferable that the operation of the fuel cell system be performed in a use environment close to room temperature, in which the fuel cell 11 and the fuel tank 12 are likely to generate a temperature difference with the outside air temperature.

According to one structural example of this embodiment, as shown in FIG. 7, there is a structure in which the thermoelectric transducer 15 is arranged so that one surface of the thermoelectric transducer is exposed to the power generating portion side of the fuel cell and another surface thereof is exposed to air.

In this case, the power generating portion side becomes the high temperature source side, whereas, the air side becomes the low temperature source side. As a result, the thermoelectric transducer 15 can generate an electromotive force based on the temperature difference.

Further, according to another structural example of the present invention, as shown in FIG. 8, there is a structure in which one surface of the thermoelectric transducer 15 is exposed to the fuel tank side and another surface thereof is exposed to air. In this case, the fuel tank 12 side becomes the low temperature source and the air side becomes the high temperature side. As a result, the thermoelectric transducer 15 can generate an electromotive force based on the temperature difference between both sides.

In either case, there occur such changes that the temperature difference increases at the time of starting the fuel cell system and the temperature difference is reduced at the time of stopping the fuel cell system. As a result, the electromotive force of the thermoelectric transducer shows the same tendency.

The connection and disconnection of the resistor to the both electrodes, which become necessary at the time of start and at the time of stop, may be performed by detecting the change of the electromotive force and controlling the switch by the control unit or by the operation of the switch by the electromotive force.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-146205, filed May 26, 2006, which is incorporated herein by reference in its entirety.

1. A fuel cell system comprising:
a fuel cell comprising a power generating portion for performing power generation based on a fuel supplied from a fuel tank, the power generating portion including a fuel electrode and an oxidizer electrode; and
a switch provided between the fuel electrode and the oxidizer electrode so as to switch connection and disconnection of a resistor between and with the fuel electrode and the oxidizer electrode,
wherein the switching of the connection and disconnection of the resistor by the switch is performed based on at least one temperature difference between two of the power generating portion of the fuel cell, the fuel tank and outside air.

2. A fuel cell system according to claim 1, wherein the switch is operated based on an electromotive force generated by a thermoelectric transducer provided in at least one position between two of the power generating portion of the fuel cell, the fuel tank and outside air.

3. A fuel cell system according to claim 1, wherein the switch is operated by an electromotive force generated by a thermoelectric transducer provided in a position between two of the power generating portion of the fuel cell, the fuel tank and outside air.

4. A fuel cell system according to claim 3, wherein the switch brings the resistor into a connection state when the electromotive force of the thermoelectric transducer is less than a predetermined value, and brings the resistor into a disconnection state when the electromotive force of the thermoelectric transducer is the predetermined value or more.

5. A fuel cell system according to claim 2, further comprising a controller for controlling the switch by the electromotive force generated by the thermoelectric transducer, wherein the controller controls so as to bring the resistor into a state of the connection when the electromotive force of the thermoelectric transducer is less than a predetermined value, and bring the resistor into a state of the disconnection when the electromotive force of the thermoelectric transducer is the predetermined value or more.

6. A fuel cell system according to claim 2, wherein the thermoelectric transducer is provided between the power generating portion of the fuel cell and the fuel tank.

7. A fuel cell system according to claim 2, wherein the thermoelectric transducer is provided in a position at which one of a temperature difference between a temperature of the power generating portion of the fuel cell and an outside air temperature and a temperature difference between a temperature of the fuel tank and the outside air temperature can converted into an electric power.

8. A fuel cell system according to claim 1, wherein the fuel cell comprises a fuel cell stack in which a plurality of fuel cell units are stacked, the resistor is provided in plurality, respective resistors are connected to every fuel cell units.

9. A fuel cell system according to claim 1, wherein the fuel tank is filled with one of high pressure hydrogen and hydrogen stored in hydrogen storage alloy.
